(19) United States
(12) Patent Application Publication
(10) Pub. No.: US 2018/0344564 A1
(43) Pub. Date: Dec. 6, 2018

(54) COLLAR-TYPE MASSAGE DEVICE

(71) Applicants: Anke REINIGER, Wallhausen (DE); Heiko STEINBACH, Wallhausen (DE)

(72) Inventors: Anke REINIGER, Wallhausen (DE); Heiko STEINBACH, Wallhausen (DE)

(21) Appl. No.: 15/778,696

(22) PCT Filed: Aug. 17, 2016
(86) PCT No.: PCT/EP2016/001405

§ 371 Date: May 24, 2018

(30) Foreign Application Priority Data
Nov. 25, 2015 (DE) 10 2015 015 265.3
Jun. 2, 2016 (DE) 10 2016 006 770.5
Jul. 12, 2016 (DE) 10 2016 008 464.2

(51) Int. Cl. A61H 7/00

(52) U.S. Cl. CPC A61H 7/004; A61H 7/007; A61H 2007/009; A61H 2201/165; A61H 2015/0014; A61H 2201/5038; A61H 2201/0149; A61H 2207/00; A61H 2201/1463

(57) ABSTRACT

A collar-type massage device has at least two longitudinal, dimensionally-stable massage organs, each massage organ including an electric motor and at least two massage elements that are spaced apart from one another in the longitudinal direction of the massage organ and that can be rotatably driven by the electric motor, a flexible collar housing being provided which includes at least two storage spaces for the longitudinal massage organs, these spaces being separated from one another and oriented in the transverse direction of the collar-type massage device, and the spaces being delimited by a body-side inner surface element and a storage space delimiting surface element. A flexible hook-and-loop device projects laterally away from the flexible collar housing.

The invention relates to a collar-type massage device.

From DE 20 2014 006 715 U1 a collar-type massage device is known, which has a strip-shaped flexible base surface element, on the upper side of which miniature electric motors are mounted spaced apart from each other. A strip-shaped flexible cushioning layer is designed with recesses for the miniature electric motors. A massage element is provided eccentrically on the shaft of the respective miniature electric motor. The massage elements protrude from the cushioning layer in a rigid or springy way. A strip-shaped flexible bottom surface element is provided on the underside of the base surface element and a strip-shaped flexible top surface element is provided on the top side of the cushioning layer. The bottom surface element and the top surface element enclose the base surface element with the miniature electric motors and the cushioning layer on all sides. This well-known massage device has a number of miniature electric motors corresponding to the number of massage elements.

A massage device designed for installation in a chair, seat or car seat is known from DE 202 07 738 U1. The massage device is provided with massage elements acting on a massage surface and a drive by means of which the massage elements are moved in a plane which is parallel and/or acute-angled to the massage surface. As drive an electric motor has been provided whose drive shaft is essentially parallel and/or acute-angled to the massage surface. This well-known massage device can have two drives, which are arranged next to each other and oriented oppositely.

The objective of the invention is to create a collar-type massage device of the kind first mentioned above, by means of which an optimal massage effect can be achieved.

In accordance with the invention, this objective is accomplished by the characteristics stated against claim 1, in such a manner that at least two elongated dimensionally stable massage organs are provided, with each massage organ being provided with an electric motor and at least two massage elements which are spaced apart in the longitudinal direction of the massage organ and can be driven rotatably by means of the electric motor, in that a flexible collar housing is provided, which has at least two separate storage spaces for the elongated massage organs oriented in the transverse direction of the collar-type massage device, wherein the storage spaces are delimited by an inner surface element close to the body and a storage space limiting surface element, and that a flexible velcro device protrudes laterally from the flexible collar housing.

It may be useful in this context if the massage device according to the invention has at least three elongated, dimensionally stable massage organs, each of which being provided with an electric motor. Furthermore, it can be useful if the respective massage organ is provided with three, four or more massage elements that can be rotatably driven by means of the associated electric motor. According to the number of elongated, dimensionally stable massage organs, the flexible collar housing is also designed with a corresponding number of storage spaces for the elongated massage organs.

In the massage device according to the invention, the respective elongated massage organ can have an elongated, dimensionally stable housing in which the electric motor is provided arranged in a longitudinally oriented manner, said motor being operatively connected to output gears mounted vertically in the elongated housing in such a way that the output gears arranged adjacent to one another are driven in opposite rotational directions, with said output gears having axes of rotation which project from the housing of the massage organ and the body-near inner surface element with a section on which an associated massage element is provided in a torsionally resistant manner.

The longitudinally oriented, horizontal electric motor is operatively connected to the output gears mounted vertically in the elongated housing, e.g. by means of a bevel gear unit, a worm gear unit or the like.

It is viewed advantageous if the output gears located adjacent to each other are driven in opposite rotational directions, so that an unwanted longitudinal movement of the switched-on collar-type massage device is reliably prevented if, for example, it has been applied around a person's thigh. In order to bring about the opposite rotational directions of the respective adjacently arranged output gears of the respective elongated massage organ in a simple manner, it has proven to be useful if a pair of couple gears is provided rotatably mounted between adjacently located output gears in the elongated massage organ, said couple gears meshingly engage with each other and with the associated output gears.

According to an invention, the respective massage element can be provided with a disk-shaped basic component which is connected so as to be torsionally resistant to the section of the axis of rotation of the associated output gearwheel projecting from the housing of the elongated massage organ and the inner surface element located close to the body, and from which at least one massage peg protrudes eccentrically. It is considered advantageous here if a pair of massage pegs stand upwards from the basic component of the respective massage element, said pegs are arranged radially opposite each other in relation to the section of the associated output gearwheel axis projecting from the upper side of the housing. The massage pegs can have the same height dimensions from the basic component of the respective massage element or be of different lengths. The respective massage element is fixed in a torsionally resistant manner to the axis of rotation of the corresponding output gear. This can be achieved, for example, by providing a tongue and groove connection. Another possibility is, for example, that the respective axis of rotation has a cross-section deviating from the circular form and the basic component of the associated massage element is designed to have a recess adapted to it without play.

In accordance with the invention, it is also possible that the massage elements are formed by massage rollers which are spaced apart from each other mounted in the transverse direction of the elongated housing and project out of the housing with a massage section, and that the electric motor in the housing is arranged in a parallel orientation to the massage elements.

In this configuration, the massage elements are not formed as eccentric massage pegs on a disk-shaped basic component but as massage rollers, which are mounted spaced apart from each other in the transverse direction of the elongated housing. The electric motor as well is arranged in the elongated housing in a space-saving manner, so that its space requirement in a collar-type massage device is comparatively small.

The massage rollers may have a cylindrical surface. Another possibility is that the massage rollers are provided with a crowned surface.

The surface of the respective massage roller can be provided with a massage structure that can be formed by studs, ribs, grooves, waves or the like.

At least on one side of the respective massage roller one drive gear each is provided in a torsion resistant manner, preferably located axially opposite to each other. In order that the drive gears do not impair the effect of the massage rollers in any way, i.e. do not make themselves disturbingly noticeable, it has proved useful for the massage rollers to have a larger diameter than the drive gears. Neighboring drive gears can meshingly engage with a pair of couple gears each. By such a configuration it is very easily accomplished that the massage rollers each protrude with a massage section from the elongated housing and the drive gears as well as the couple gears are rotatably mounted between adjacent drive gears in the elongated housing in such a way that they do not protrude from the upper side of the housing.

Another possibility is that the drive gears engage meshingly with an associated double-sided toothed belt in a meandering ascending and descending manner. A reliable meshing engagement of the respective double-sided toothed belt with the associated drive gears can easily be achieved in that at least one tightening pulley is provided for mechanically tensioning the respective double-sided tensioning belt.

The inner surface element and/or the storage space limiting element can be made of a flexible material.

The storage space limiting element may also consist of a dimensionally stable material which is assigned to the storage spaces by hinge elements.

An outer surface element located remotely from the body is preferably arranged adjacent to the storage space limiting element.

The outer surface element located remotely from the body may consist of a flexible material or a dimensionally stable material assigned to the storage spaces by hinge elements.

The flexible inner surface element located near the body and the storage space limiting surface element can, for example, consist of a textile material, leather, artificial leather or the like. The flexible or dimensionally stable outer surface element located remotely from the body may be made of a material similar to that of the inner surface element or any other material. It is important that the materials meet the required hygiene, cleaning, etc. requirements.

According to the invention, it is viewed advantageous if the storage space limiting surface element has a corrugated profile relative to the inner surface element of the flexible collar housing in the transverse direction of the collar-type massage device and is firmly attached to the inner surface element. Such a design offers the advantage that the flexible inner surface element located near to the body can have a quasi planar configuration so that the massage elements are capable of being optimally effective if the massage device has been applied, for example, to the thigh of a person and switched on.

It is advantageous if a cushioning element embracing the pertinent dimensionally stable, elongated massage organ is provided in the respective storage space of the flexible collar housing. The cushioning element may, for example, consist of a closed-cell foam material that forms a self-supporting body in which the associated longitudinal, dimensionally stable massage organ is embedded. For this purpose, the self-supporting body can be provided with a recess for the elongated massage organ.

According to the invention, it is also possible that a cushioning element is provided in the outer space limited by the wave-shaped profiled storage space limiting surface element and the outer surface element. In the latter configuration described hereinbefore, it is advantageous if the cushioning element provided in the outer space is softer than the cushioning elements arranged in the storage spaces of the flexible collar housing.

It has proved to be beneficial if in the massage device proposed by the invention the flexible velcro device protrudes from a transverse side of the flexible collar housing, and if the collar housing is provided with a folding bracket device for the flexible velcro device arranged on its other transverse side facing away from the velcro device. Said velcro device may consist of a single velcro surface and the folding bracket device may consist of a single folding bracket adapted to it. After the massage device proposed in accordance with the invention is used on a person's thigh, for example, and considering the fact that thighs regularly have a larger circumference in the vicinity of the person's torso than in the vicinity of the knee, it is preferred that the velcro device is provided with two adjacent velcro surfaces and the folding bracket device has folding brackets adapted to the two velcro surfaces. A massage device designed in this way can be optimally applied to a person's thigh so that an excellent massage effect is brought about when the massage device is switched on, i.e. connected to a power supply.

The electric motors of the massage organs are expediently connected with each other in such a way that they can operate effectively together.

When in particular the inventive massage device is designed to comprise two velcro surfaces located side by side and two folding brackets suitably adapted to them, it can be of advantage if the two transverse sides of the flexible collar housing enclose an acute angle.

Further details, characteristics, and advantages arise from the following description of the embodiment examples of the inventive collar-type massage device schematically shown in the drawings, where

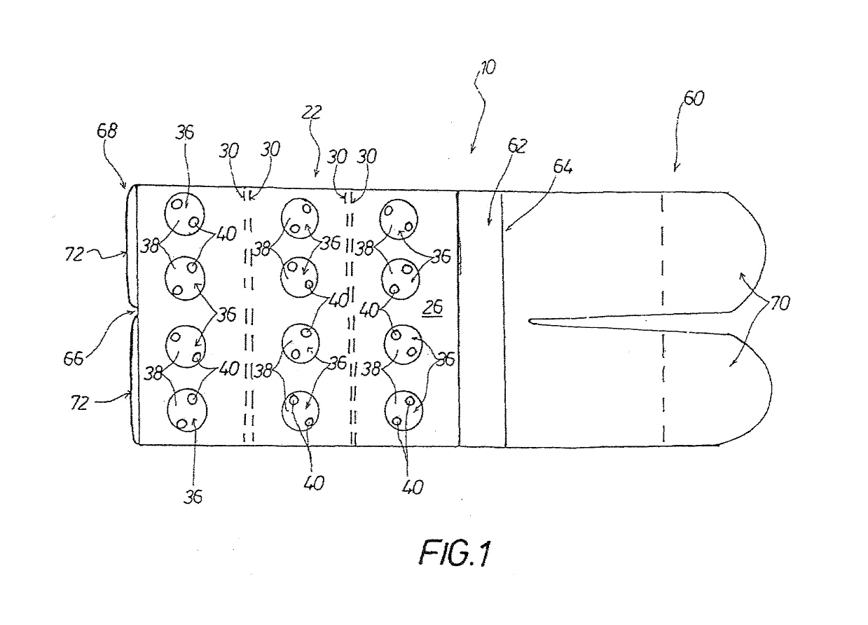

FIG. 1 shows the massage device viewed in the direction of the massage device with its massage elements,

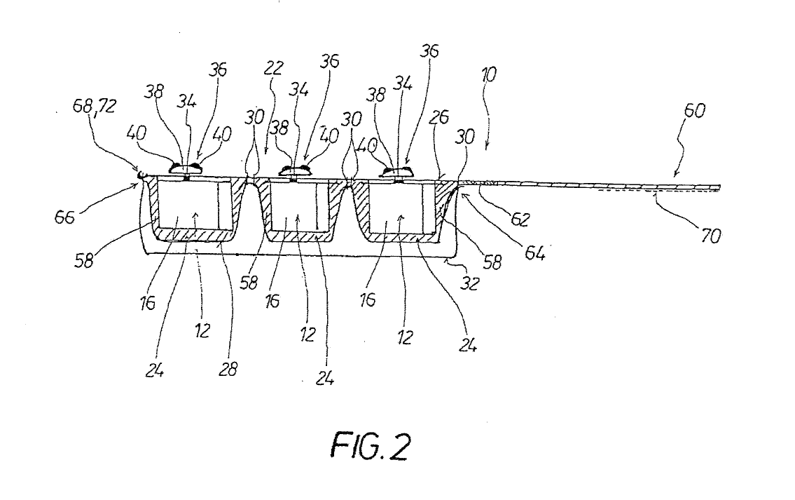

FIG. 2 is a sectional view through the massage device according to FIG. 1,

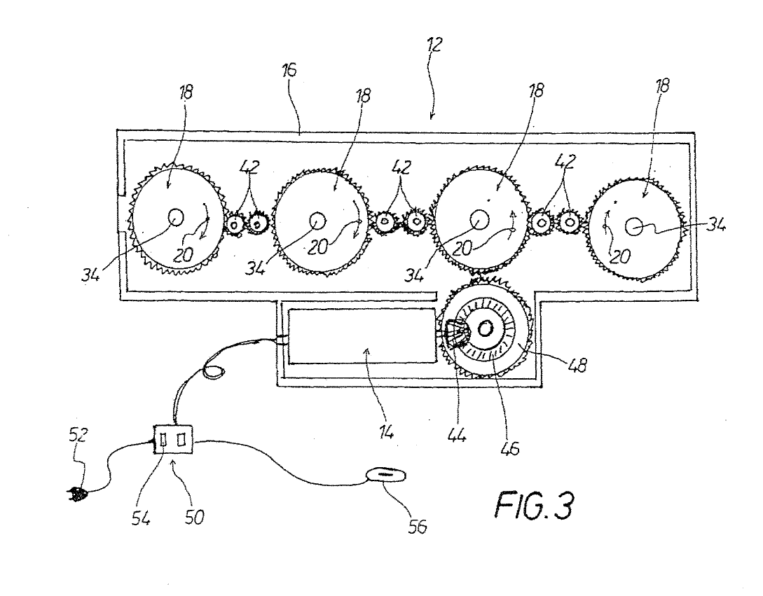

FIG. 3 illustrates a section through an elongated, dimensionally stable massage organ of the collar-type massage device according to FIGS. 1 and 2,

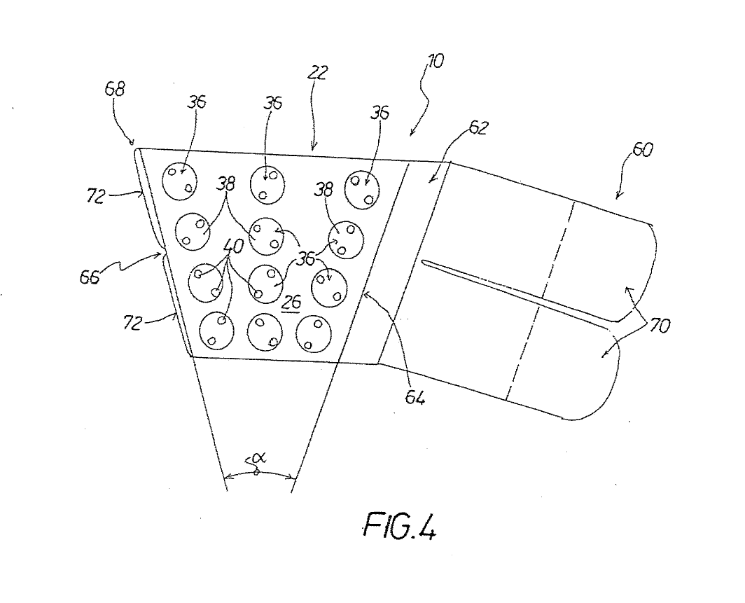

FIG. 4 is similar to FIG. 1, with the two transverse sides of the flexible massage housing enclosing an acute angle “α”,

FIG. 5 shows a top view of another embodiment of the massage organ,

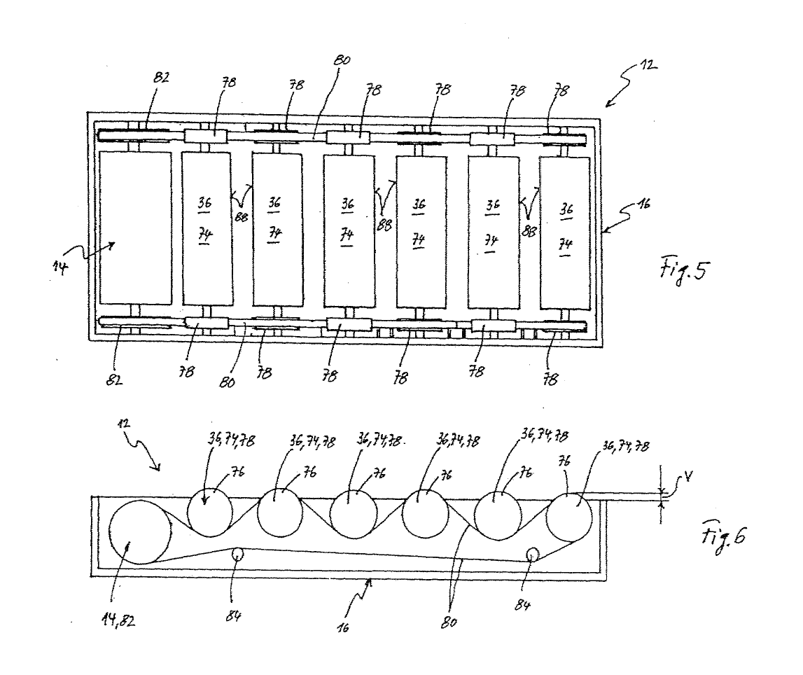

FIG. 6 shows a longitudinal section through the massage organ according to FIG. 5,

FIG. 7 illustrates another embodiment of the massage organ in a view from above,

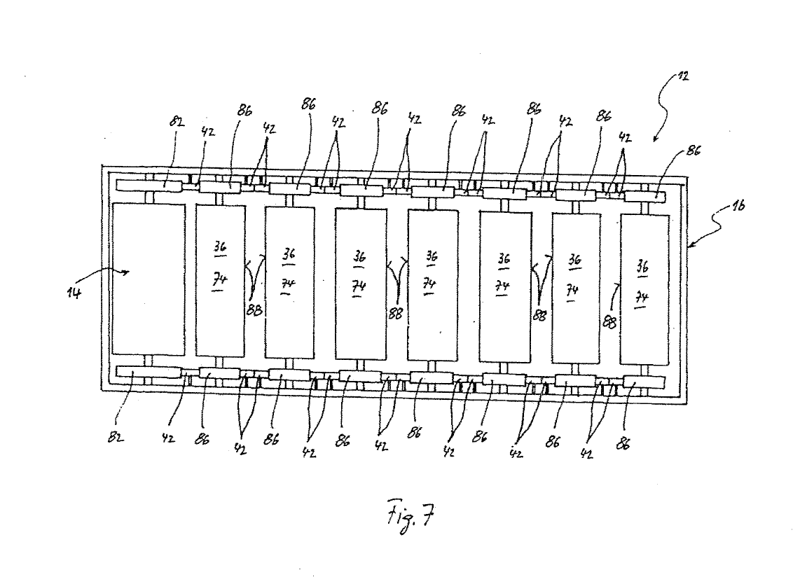

FIG. 8 is an illustration similar to FIG. 7 of a section of the massage organ according to FIG. 7,

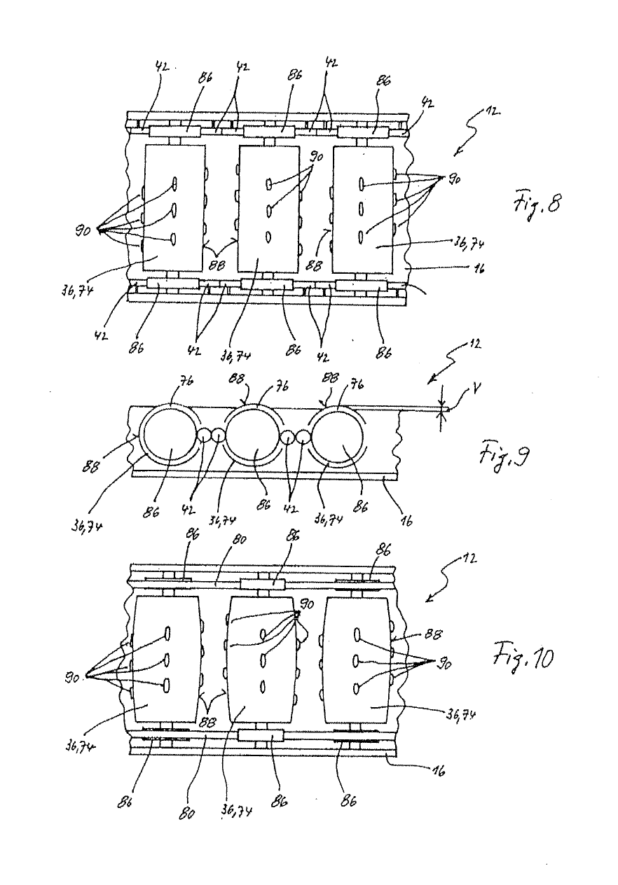

FIG. 9 sectionally depicts schematically a longitudinal section of the embodiment according to FIG. 8, and

FIG. 10 is a representation similar to FIG. 8 to illustrate massage rollers having a crowned surface.

FIG. 1 shows an embodiment of the collar-type massage device 10, and as can be seen in FIG. 2, the massage device 10 is provided with three elongated, dimensionally stable massage organs 12. A massage organ 12 is shown FIG. 3. Each massage organ 12 has an electric motor 14.

Other embodiments of a massage organ 12 are further described in connection with FIGS. 5 to 10.

The elongated, dimensionally stable massage organ 12 illustrated in FIG. 3 has an elongated, dimensionally stable housing 16 in which the electric motor 14 is arranged in horizontal position. In this manner, a small overall height of the massage organ 12 can be achieved.

The elongated, dimensionally stable massage element 12 has output gears 18, which are rotatably mounted in the elongated housing 16. The electric motor 14 is operatively connected to the output gears 18, whereby the output gears 18 adjacent to each other are driven in opposite rotational directions. In FIG. 3 this has been indicated by the curved arrows 20.

The collar-type massage device 10 is provided with a flexible collar housing 22, which—as can be seen from FIG. 2—has three separate storage spaces 24 for the elongated massage organs 12, said spaces being oriented in the transverse direction of collar housing 22 of collar-type massage device 10. The storage spaces 24 are limited on the one hand by a body-near, quasi planar inner surface element 26 of the flexible collar housing 22 and on the other hand by a quasi wave-shaped profiled storage space limiting surface element 28. The storage space limiting surface element 28 is connected in a wave-like manner to the inner surface element 26 arranged so as to be close to the body. This connection is made, for example, by connecting seams 30.

Moreover, the flexible collar housing 22 is provided with an outer surface element 32 located remotely to the body. The outer surface element 32 is firmly connected to the inner surface element 26 located close to the body, e.g. by means of pertinent connecting seams 30.

The output gears 18 of the respective elongated massage organ 12 have rotational axes 34, which are designed, for example, to have a cross-section deviating from the circular shape and which project from the flexible body-near inner surface element 26 of the flexible sleeve housing 22 with a section on the upper side at which the pertinent associated massage element 36 is arranged in a torsion-resistant manner. The massage element 36 exhibits a basic component 38 which is connected in a torsion-resistant manner to the last-mentioned section of the relevant axis of rotation 34 of the respective output gearwheel 18. A pair of massage pegs 40 of the basic component 38 stand eccentrically upwards. The two massage pegs 40 are radially opposite each other in relation to the axis of rotation 34 of the output gear.

As can be seen in FIG. 3, a pair of couple gears 42 are rotatably mounted between neighboring output gears 18 in the elongated, dimensionally stable housing 16 of the respective massage organ 12, said couple gears meshingly engage with each other and with the associated output gears 18. FIG. 3 furthermore illustrates a bevel gearwheel structure comprising a bevel gear 44, which is connected in a torsionally resistant fashion to the shaft of the electric motor 14, and which meshingly engages with bevel gear 46, which is connected in a torsionally resistant manner to a coaxial couple gear 48, which meshingly engages with one of the output gears 18 to enable an operative connection to be achieved between the electric motor 14 and the output gears 18. Instead of a bevel gear unit, a worm gear unit is also conceivable, for example, to operatively connect the horizontally situated electric motor 14 with the vertical output gears 18.

FIG. 3 schematically shows an electrical power supply unit with reference numeral 50, which is connected to electric motor 14 and which can be connected to a mains supply via a mains plug 62. The power supply unit 50 has an on/off switch 54 and a controller 56 by means of which the rotational speed of the output gears 18 can be adjusted as desired. The power supply unit 50 may as well be provided with a programmable controller device.

As can be seen from FIG. 2, the storage space limiting surface element 28 is firmly attached in a wave-shaped manner to the body-near inner surface element 26 of the flexible collar housing 22 in the transverse direction of the massage device 10 in order to form the storage spaces 24 for the elongated, dimensionally stable massage organs 12. The inner surface element 26 located near the body can have a quasi flat/planar shape.

A cushioning element 58 embracing the pertinent dimensionally stable, elongated massage organ 12 is provided in the respective storage space 24 of the flexible collar housing 22. The respective cushioning element 58 can be of self-supporting troughlike design to accommodate and appropriately position the relevant massage organ 12.

As can be seen from FIGS. 1 and 2, a flexible velcro device 60 is positioned to and protrudes from the side of the flexible collar housing 22. The velcro device 60 is connected to the collar housing 22 by means of an expandable strip-shaped surface element 62 to enable the collar-type massage device 10 proposed by the invention to be adapted to the most varied thigh dimensions of persons.

The flexible velcro device 60 projects from one transverse side 64 of the flexible collar housing 22. The collar housing 22 is provided with a folding bracket device 68 for the flexible velcro device 60, said bracket device being arranged on the other transverse side 66 located opposite to the side of the velcro device 60. In the event the Velcro device 60 comprises two velcro faces 70 situated side by side, it is advisable and expedient for the folding bracket device 68 to consist of two folding brackets 72 appropriately adapted to this configuration. It may be useful in this context if the two transverse sides 64 and 66 enclose an acute angle α, as can be seen from FIG. 4.

In FIGS. 5 and 6 a different embodiment of the massage organ 12 for a massage device 10 is shown, said massage organ 12 having an elongated, dimensionally stable housing 16 open at the top and having a rectangular footprint. An electric motor 14 is arranged in the elongated housing 16, said motor being intended to drive massage elements 36 mounted rotatably in the housing 16. The massage elements 36 are formed by massage rollers 74, which are oriented in the transverse direction of the elongated housing 16 and supported at a distance from each other.

As is evident from FIG. 6, each of the massage rollers 74 has a massage section 76 which protrudes from the housing 16. In FIG. 6, the protruding section of massage sections 76 is marked “V”.

As can be seen in FIG. 5, the electric motor 14 is arranged in an elongated housing 16 oriented parallelly to the massage elements 36.

At the respective massage roller 74, drive gears 78 are arranged axially opposite each other, i.e. at the respective roller sides, in a torsionally resistant way. As can be seen from FIG. 6, each of the drive gears 78 of the massage rollers 74 meshingly engages with an associated double-sided toothed belt 80 in a meandering ascending and descending manner. Each of the two laterally arranged double-sided toothed belts 80 meshingly engages with an associated output gear 82, which is connected to the electric motor 14 in a torsion-resistant way.

With a view to mechanically tensioning the respective double-sided toothed belt 80, tightening pulleys 84 are mounted in the housing 16 by means of which a reliable meshing engagement of the toothed belts 80 with the associated drive gears 78 of the massage rollers 74 and with the output gears 82 of the electric motor 14 is always warranted.

As a result of the meandering run of the double-sided toothed belt 80, massage rollers 74 arranged side by side are each driven in the opposite direction of rotation.

In FIG. 7 an embodiment of the massage organ 12 is illustrated with the electric motor 14 arranged in the elongated housing 16 and massage rollers 74 which are connected in a torsionally resistant manner to axially opposite drive gears 86. The electric motor 14 is connected axially opposite to an output gear 82 each in a torsion resistant manner. The massage rollers 74 have a larger diameter than the drive gears 86 (see FIG. 9) to ensure that a protruding massage section “V” is created which is designated by reference numeral 76. Between neighboring drive gears 86, a pair of couple gears 42 are each provided, said couple gears engage meshingly with the drive gears 86.

While FIGS. 5, 7 and 8 each show massage rollers 74, which are designed to have a cylindrical generated surface 88, FIG. 10 illustrates an embodiment of the massage organ 12 wherein the massage rollers 74 are designed to have a crowned generated surface 88.

The surface 88 of the respective massage roller 74 can be designed to have studs 90 forming a massage structuring or pattern of the respective massage roller 74. For example, the surface 88 of the respective massage roller 74 can be formed with ribs, grooves, waves or the like.

The collar-type massage device proposed by the present invention is intended, for example, to reduce or prevent cellulite. Another possible application of the inventive massage device is to counteract tissue weakness, for muscle relaxation, muscle stimulation, regeneration, to improve the blood circulation and/or for lymphatic massage by attaching the massage device to a person's upper arm or calf.

### LIST OF REFERENCE NUMERALS

10 collar-type massage device
12 longitudinal dimensionally stable massage organ (of 10)
14 Electric motor (of 10 in 12)
16 dimensionally stable housing (of 12)
18 output gears (in 16)
20 bow-shaped arrow (in 18)
22 flexible collar housing (of 10)
24 storage spaces (in 22 for 12)
26 flexible body-near inner surface element (of 22)
28 flexible storage space limiting surface element (of 22)
30 Connecting seams (between 26 and 28 or 30)
32 flexible outer surface element (distant from body) (of 22)
34 rotational axis (of 18 for 36)
36 massage elements (on 34)
38 disk-shaped basic component (of 36)
40 massage peg (on 38)
42 Couple gears (in 16 between 18 and 18)
44 bevel gear (of 14)
46 bevel gear (for 48)
48 couple gear (on 46 for 18)
50 electric power supply unit (of 10 for 14)
52 mains plug (of 50)
54 on/off switch (of 50)
56 controller (of 50)
58 cushioning element (in 24 for 14)
60 velcro device (of 10 on 22)
62 expandable strip element (between 22 and 60)
64 transverse side (of 22)
66 second transverse side (of 22)
68 Folding bracket device (on 66)
70 velcro faces (of 60)
72 folding bracket (of 68)
74 massage rollers (of 10)
76 massage section (of 74)
78 Drive gears (on 74)
80 toothed belt (for 74)
82 output gears (on 14)
84 tightening pulley (for 80)
86 gear wheels (on 74)
88 generated surface (of 74)
90 studs (on 88)

1-26. (canceled)

27. A collar-type massage device (10) comprising spaced apart massage elements (36), wherein a flexible collar housing (22) is provided from which a flexible velcro device (60) protrudes laterally, wherein the flexible collar housing (22) has at least two separate storage spaces (24) for elongated massage organs (12) oriented in the transverse direction of the collar-type massage device (10), wherein the storage spaces (24) are limited by an inner surface element (26) located close to the body and a storage space limiting surface element (28) located remotely from the body, wherein the storage space limiting surface element (28) is corrugatedly profiled relative to the inner surface element (26) of the flexible collar housing (22) in the transverse direction of the collar-type massage device (10) and is firmly connected to the inner surface element (28), and wherein each massage organ (12) is provided with an electric motor (14) and at least two massage elements (36) spaced apart in the longitudinal direction of the massage organ (12) and rotatably drivable by the electric motor (14).

28. The massage device according to claim 27, wherein the respective elongated massage organ (12) has an elongated, dimensionally stable housing (16) in which the electric motor (14) is provided arranged in the massage organ (12) in a longitudinally oriented manner, said motor being operatively connected to output gears (18) mounted vertically in the elongated housing (16) in such a way that the output gears (18) arranged adjacent to one another are driven in opposite rotational directions, with said output gears (18) having axes of rotation (34) which project at the top from the housing (16) of the massage organ (12) and the body-near inner surface element (26) with a section on which an associated massage element (36) is provided in a torsion resistant manner.

29. The massage device according to claim 28, wherein a pair of couple gears (42) are rotatably mounted between neighboring output gears (18) in the elongated massage organ (12), said couple gears meshingly engage with each other and with the associated output gears (18).

30. The massage device according to claim 28, wherein the respective massage element (36) has a disk-shaped basic component (38) which is connected in a torsion-resistant manner to the section of the axis of rotation (34) of the associated output gear (18) protruding at the top from housing (16) of the elongated massage organ (12) and the inner surface element (26) located near the body, and with at least one massage peg (40) projecting eccentrically upwards from said basic component.

31. The massage device according to claim 30, wherein a pair of massage pegs (40) project upwards from the basic component (38) of the respective massage element (36), said pegs are arranged radially opposite each other in relation to the section of the associated output gear axis of rotation (34) projecting from the upper side of the housing (16).

32. The massage device according to claim 27, wherein the respective massage organ has an elongated, dimensionally stable housing (16) in which the electric motor (14) for driving the massage elements (36) mounted in the housing (16) is provided oriented in the transverse direction of the massage organ, with the massage elements (36) being formed of massage rollers (74) which are mounted spaced apart from one another in the transverse direction of the elongate housing (16) and project from the housing (16) with a massage section (76).

33. The massage organ according to claim 32, wherein the massage rollers (74) have a cylindrical generated surface (88).

34. The massage organ according to claim 32, wherein the massage rollers (74) have a crowned generated surface (88).

35. The massage organ according to claim 33, wherein the generated surface (88) of the respective massage roller (74) is designed to have a massage structuring (90).

36. The massage organ according to claim 32, wherein a drive gear (78) each is provided on the respective massage roller (74) at least on one side, preferably axially opposite each other.

37. The massage organ according to claim 36, wherein the massage rollers (74) have a larger diameter than the drive gears (78).

38. The massage organ according to claim 36, wherein neighboring drive gears (78) are each meshingly engaged with a pair of couple gears (42).

39. The massage organ according to claim 36, wherein the drive gears (78) meshingly engage with an associated double-sided toothed belt (80) in a meandering ascending and descending manner.

40. The massage organ according to claim 39, wherein at least one tightening pulley (84) is provided for mechanically tensioning the respective double-sided toothed belt (80).

41. The massage organ according to claim 27, wherein the inner surface element (26) comprises a flexible material.

42. The massage organ according to claim 27, wherein the storage space limiting element (28) comprises a flexible material.

43. The massage organ according to claim 27, wherein the storage space limiting element (28) comprises a dimensionally stable material which is assigned to the storage spaces (24) by hinge members.

44. The massage organ according to claim 27, wherein an outer surface element (32) located remotely from the body is arranged adjacent to the storage space limiting element (28).

45. The massage organ according to claim 27, wherein the outer surface element (32) located remotely from the body comprises a flexible material.

46. The massage organ according to claim 27, wherein the outer surface element (32) located away from the body comprises a dimensionally stable material which is assigned to the storage spaces (24) by hinge members.

47. The massage device according to claim 27, wherein a cushioning element (58) embracing the relevant dimensionally stable, elongated massage organ (12) is provided in the respective storage space (24) of the flexible collar housing (22).

48. The massage device according to claim 44, wherein a cushioning element is provided in the outer space limited by the storage space limiting surface element (28) and the outer surface element (32).

49. The massage device according to claim 27, wherein the flexible velcro device (60) protrudes from a transverse side (64) of the flexible collar housing (22), and the collar housing (22) is provided on its other transverse side (66) facing away from the velcro device (60) with a folding bracket device (68) for the flexible velcro device (60).

50. The massage device according to claim 49, wherein the velcro device (60) has two velcro faces (70) arranged adjacent to each other and the folding bracket device (68) is provided with folding brackets (72) adapted to the two velcro faces (70).

51. The massage device according to claim 49, wherein the two transverse sides (64, 66) of the flexible collar housing (22) together enclose an acute angle (α).
